(19) United States
(12) Patent Application Publication
(10) Pub. No.: US 2012/0291256 A1
(43) Pub. Date: Nov. 22, 2012

(54) METHOD AND APPARATUS FOR DORSALLY CARRYING A DEVICE

(76) Inventor: David Chen Yu, Laguna Niguel, CA (US)

(21) Appl. No.: 13/108,776

(22) Filed: May 16, 2011

(51) Int. Cl. B23P 11/00; F16M 13/02

(52) U.S. Cl. 29/428; 248/682

(57) ABSTRACT

Systems and methods for carrying an electronic device on a hand includes a base plate; a palm strap coupled to the base plate to secure the base plate to the hand; and a moveable plate coupled to the base plate through at least a horizontal hinge and a vertical hinge to position the mobile device in a horizontal landscape mode or a vertical portrait mode.

### BACKGROUND OF THE INVENTION

The present invention pertains to a method and apparatus for dorsally carrying a portable electronic device.

Personal electronic devices have become extremely popular, providing on-the-go entertainment and data access as well as mobile phone service. Other personal electronic devices such as music players and video players have also gained in use and popularity.

Personal electronic devices are often carried in a pocket or purse, or may be attached to a holster attached to a belt. While some cases may offer protection alone, this protection often fails to provide quick access, ease of use and may take up room in a pocket or handbag.

### SUMMARY

In one aspect, a method for storing and using an electronic device includes mounting the electronic device on a moveable plate attached to the moveable plate through at least a horizontal hinge and a vertical hinge; securing the base plate using a palm strap on a hand; and adjusting the moveable plate through at least a horizontal hinge and a vertical hinge to position the mobile device in a horizontal landscape mode or a vertical portrait mode.

In another aspect, systems and methods for carrying an electronic device on a hand includes a base plate; a palm strap coupled to the base plate to secure the base plate to the hand; and a moveable plate coupled to the base plate through at least a horizontal hinge and a vertical hinge to position the mobile device in a horizontal landscape mode or a vertical portrait mode.

Implementations of the above aspects may include one or more of the following. A tether or coil can be used to hold the base plate to the moveable plate. A detachable retainer can extend from the moveable plate to at least partially grip a back of the electronic device. One or more fixed retainers extending from the moveable plate can be used to at least partially enclose the electronic device. The palm strap can include a palm ventilation hole. The palm strap can include Velcro or other means for securing the palm strap to the hand. The base plate can have a lock tab to secure the moveable plate to the base plate. The moveable plate can include one or more holes, each hole receiving a pin or a screw to secure the mobile device to the moveable plate. One or more slots can be provided on the base plate to receive the palm strap. The palm strap can be a brace. Additional slots can be added to adjust the palm strap to different palm sizes. The detachable retainer can have a snap at one end and wherein the movable plate comprises tracks that cooperate with a snap on the detachable retainer and lock at a predetermined length on the tracks. A detachable hinge can connect the base plate and the moveable plate. A pin assembly can be used that includes a moving pin and a spring inside a chamber.

Advantages of the preferred embodiment may include one or more of the following. The system provides a flexible, yet convenient and light weight support for a tablet style personal electronic device. The system is particularly desirable for hands-free use. Certain embodiments of the system support multiple devices, including a cellular phone and a tablet at once. The system has a storage mode where the arms and the tablet and/or phone are retracted into a compact configuration for storage purposes.

Various aspects and embodiments of the invention are described in further detail below.

### BRIEF DESCRIPTION OF THE SEVERAL VIEWS OF THE DRAWINGS

The present invention described herein will become apparent from the following detailed description considered in connection with the accompanying drawings, which disclose several embodiments of the invention. It should be understood, however, that the drawings are designed for the purpose of illustration and not as limits of the invention.

FIG. 1 shows an exemplary mobile electronic palm carrier in a stowed mode.

FIG. 2 shows an exemplary view of the mobile electronic palm carrier during use in the palm.

FIG. 3 shows an exemplary view of the mobile electronic palm carrier perched atop a base plate through a vertical hinge.

FIG. 4 shows another view of the mobile electronic palm carrier perched atop the base plate through a horizontal hinge.

FIG. 5 shows exemplary details on the vertical and horizontal hinges connecting the base plate and moveable plate.

FIGS. 6A and 6B show exemplary outside and inside views of the movable plate.

### DETAILED DESCRIPTION OF THE INVENTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

In the following paragraphs, the present invention will be described in detail by way of example with reference to the attached drawing, which are not to scale. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention provides for an efficient and convenient apparatus for hands-free use of a tablet style personal electronic device or other personal electronic device. With the device supported by the carrying system of the present invention, the user is free to type or move about.

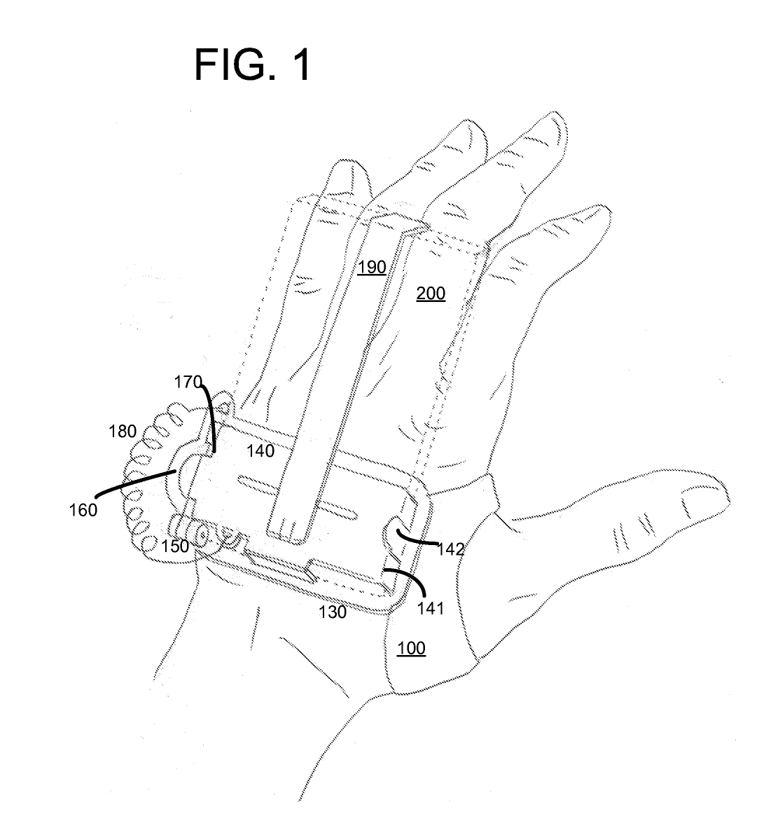

FIG. 1 shows an exemplary mobile electronic palm carrier in a stowed mode. The carrier includes a palm brace 100 that can be removably attached to a user's hand. A base plate 130 is attached to the palm brace 100. The base plate 130 is connected to the moveable plate 140 through a series of hinges. The moveable plate 140 is rotatably connected to the base plate 130 through a vertical hinge 150 that allows the moveable plate 140 to move along a first axis such as a vertical axis. One end of the vertical hinge 150 is connected to a moveable plate hinge 170 that in turn is connected to the moveable plate 140. A horizontal hinge 160 is connected to the other end of a vertical hinge 150 to allow the moveable plate 140 to move along a second axis such as a horizontal axis. The horizontal hinge 160 is rotatably connected to the base plate 130. Locking tab 142 is provided on the base plate 130 to secure the moveable plate 140 to the base plate 130. The end portion 141 of the moveable plate 140 snappably engage a locking tab 142 on the base plate 130 to lock or secure the moveable plate 140 to the base plate 130. A detachable retainer 190 is secured to the moveable plate 140 at one end, and the other end extends outwardly to form a clip that secures a mobile electronic device 200 to the moveable plate 140. A tether 180 secures the moveable plate 140 to the base plate 130.

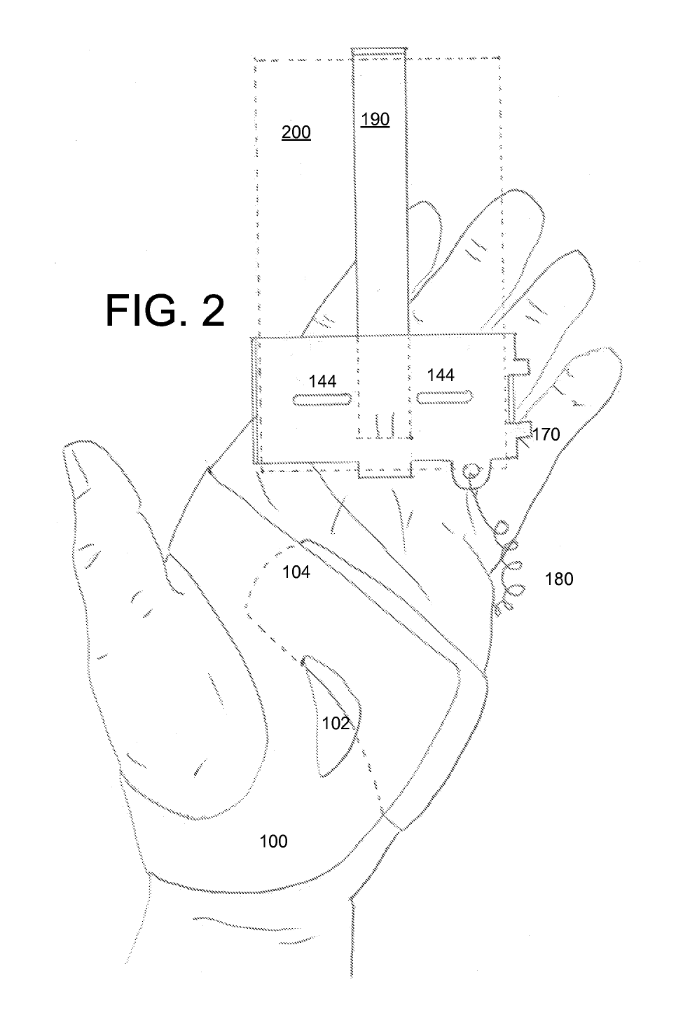

Referring now to FIG. 2, a view of the mobile electronic palm carrier during use in the palm is shown. The palm brace 100 has a ventilation hole 102 to allow cells on the hand to breath. The palm brace is secured on the inside of the palm through a suitable securing system such as loops and hooks system, a Velcro strap or a zipper strap, for example. The portable device 200 and the moveable plate 140 can be detached from the base plate 130 by detaching the moveable plate hinge 170. The moveable plate 140 has enlarged pin holes 144 to accommodate the user in punching attachment holes on the movable plate 140. The attachment holes 144 receive screws that can secure a soft mobile device case 300 to the moveable plate 140. The mobile device 200 is thus connected to the moveable plate 140 while inserted into the soft mobile device case 300 through the pin holes 144 and the detachable retainer 190, and the entire assembly is loosely bound to the base plate 130 through the tether 180.

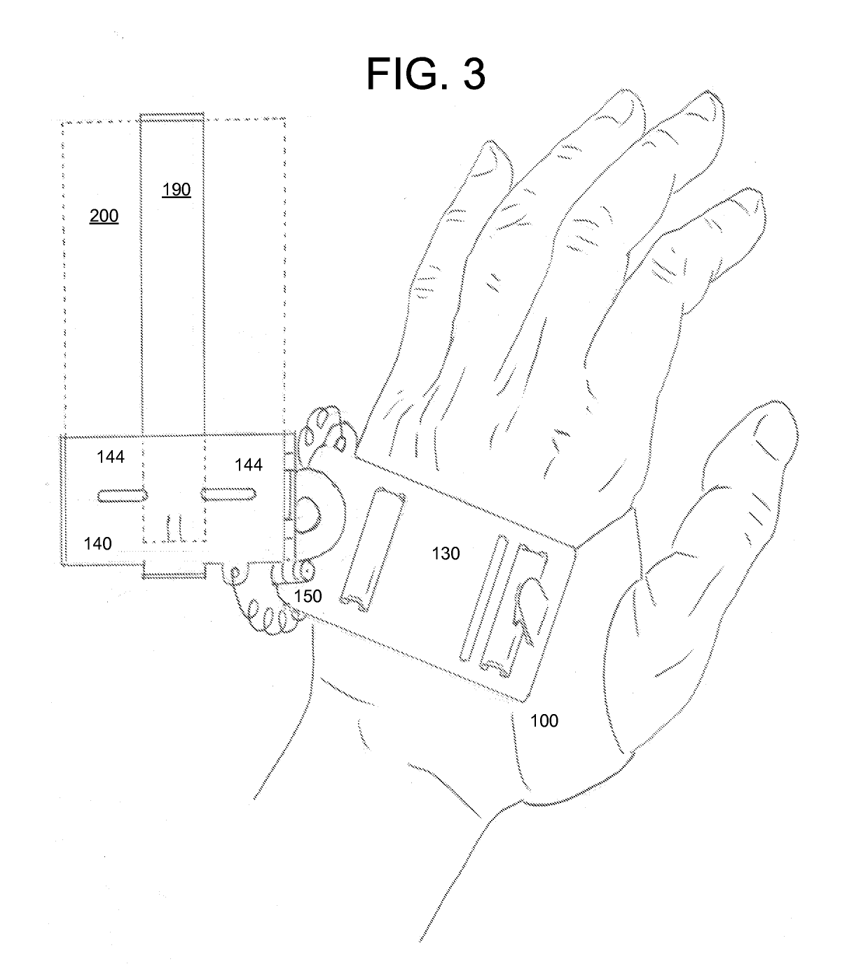

Turning now to FIG. 3, a view of the mobile electronic palm carrier perched atop the base plate 130 through the vertical hinge 150 is shown. The enlarged pin holes 144 and associated screws and the retainer 190 secure the mobile device 200 to the moveable plate 140. The mobile device 200 and the moveable plate 140 are loosely bound to the base plate 130 through the tether 180. In this mode, the device 200 is tilted up to a portrait mode from a horizontal landscape mode using the vertical hinge 150.

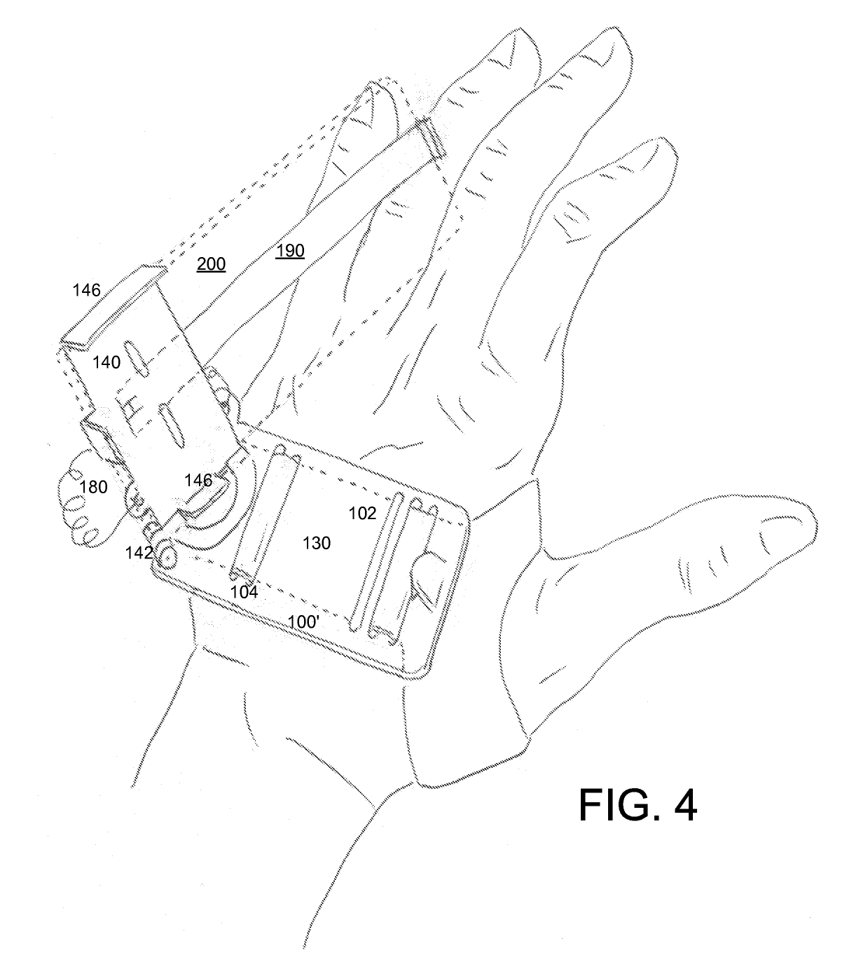

FIG. 4 shows another view of the mobile electronic palm carrier perched atop the base plate 130 through the horizontal hinge 160. The moveable plate 140 has side retainers 146 that cooperate with the detachable retainer 190 to hold the mobile device 200. The movable plate 140 is attached to a movable plate hinge 142 that cooperates with the vertical hinge 150 and the horizontal hinge 160 on the base plate 130 to enable the mobile device to tilt-up and default into a landscape mode using the moveable plate hinge 142. The horizontal hinge 160 enables the moveable plate 140 to rotate horizontally.

The base plate 130 has a series of slots 104 that enable the palm brace 100 (shown as dashed brace outline 100′) to slide through the slots 104 of the base plate 130. Additional slots 102 are positioned on the base plate 130 to adjust the brace for different palm sizes.

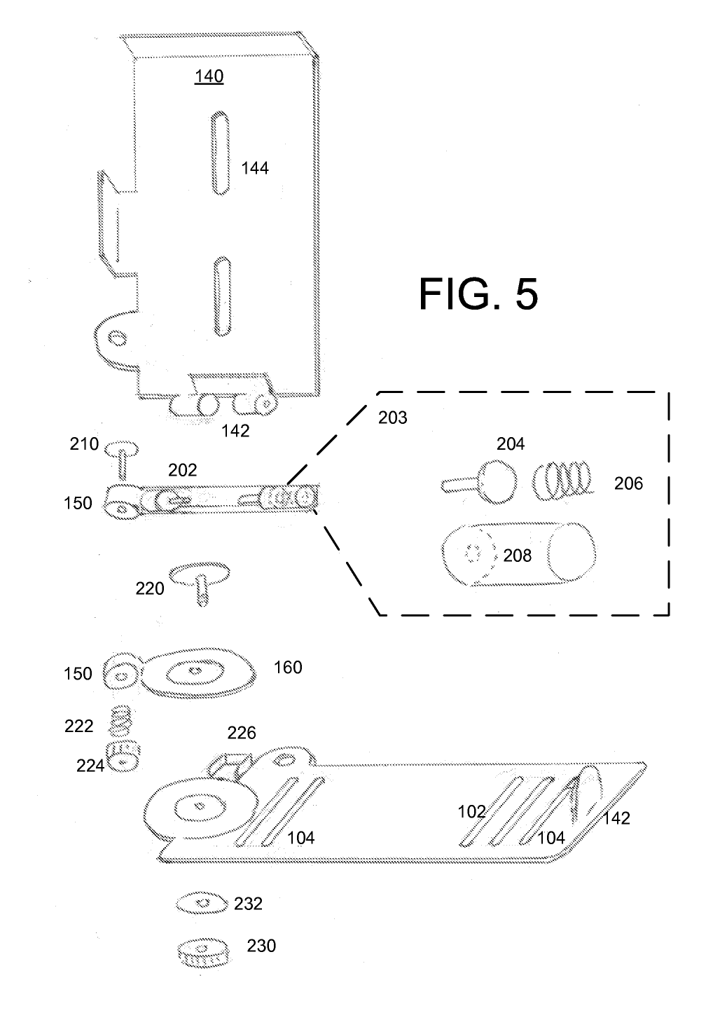

Referring now to FIG. 5, details on the vertical hinge connecting the base plate 130 and moveable plate 140 are shown. The hinge assembly of FIG. 5 includes a detachable hinge 202 with movable pin assemblies 203 that in turn are secured to the plate hinges 142. Each moving pin assembly 203 includes a moving pin 204 and a spring 206, both enclosed in a chamber 208.

A first vertical hinge 150 is positioned on one end of the detachable hinge 202. A second vertical hinge 150′ is positioned next to another horizontal hinge 160′. The horizontal hinge 160′ mates with the horizontal hinge 160 formed from one end of the base plate 130. A horizontal hinge pin 220 tightly secures the horizontal hinges 160 and 160′ through a combination of a washer 232 and a horizontal hinge nut 230. Correspondingly, a vertical hinge pin 210 secures vertical hinges 150-150′ through a spring 222 and a vertical hinge nut 224, respectively.

The moving pin assembly 203 can be depressed by the moveable plate hinge 142. Once depressed, enough room on the detachable hinge assembly is made for the movable plate hinges to be fully inserted into and locked by the hinges of the detachable hinges. The detachable hinge assembly and the locked moveable plate 140 achieve a vertical tilt using the vertical hinge 150. The horizontal rotation of the movable plate 140 is achieved through the horizontal hinge 160. In one embodiment, the movable plate hinge has a hollow center which extends mid-way in depth of the hinge.

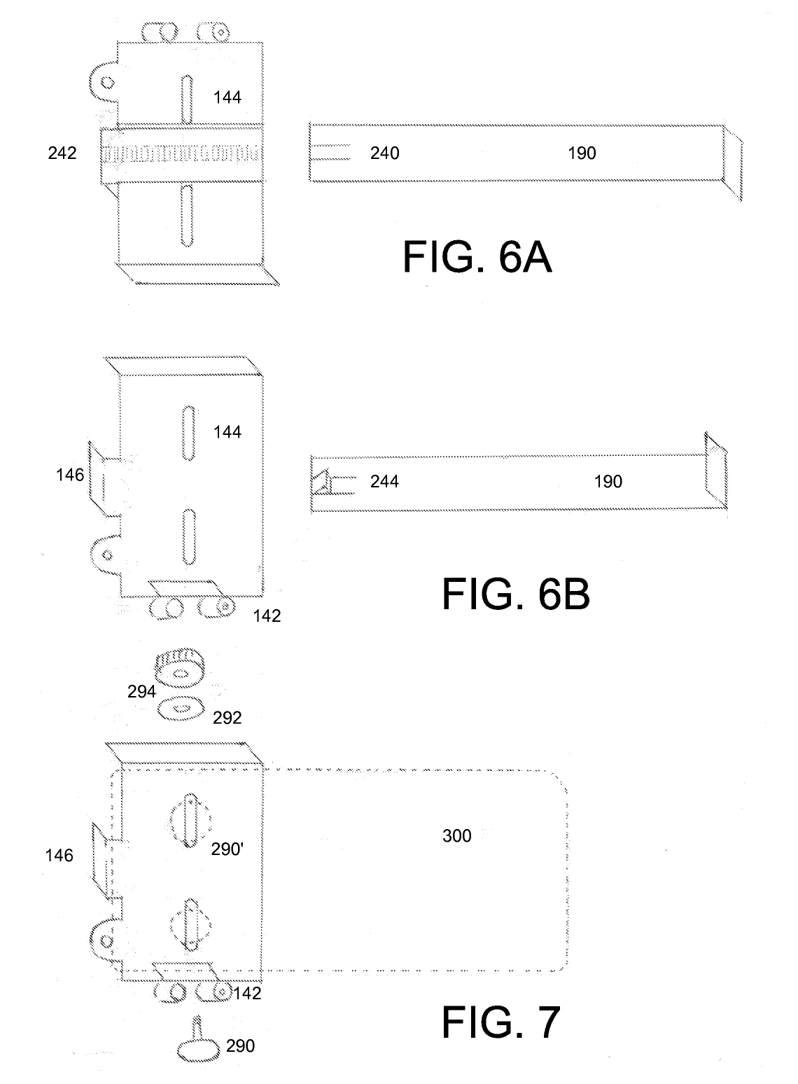

Turning now to FIGS. 6A and 6B, outside and inside views of the movable plate 140 are shown. FIG. 6A shows the outside view of the plate 140 with tracks 242 that snappably engages the detachable retainer 190 through snap 240. The detachable retainer 190 moves on the tracks 242 and is locked by the snap 240 at an appropriate length as needed to fit the mobile device 200. FIG. 6B shows the inside view of the moveable plate 140. A tab 244 projects from the snap 240.

FIG. 7 shows an embodiment that uses pins and nuts to secure the mobile device to the moveable plate. Instead of using the detachable retainer 190, the mobile device case 300 can be secured through pins and nuts on the two pin holes.

As shown in FIG. 7, pins 290 is inserted into openings 144 of the moveable plate 140 to attach the mobile device 200 (shown in a dashed outline) to the plate 140. Pins 290 are secured through washers 292 and nuts 294. After mounting, an outline of the head 290′ on top of the opening 144 can be seen.

In one embodiment, a combination of the detachable retainer 190 and the pin/nut approach of FIG. 7 can be used to support heavy mobile devices.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus for carrying an electronic device on a hand, comprising:
a base plate;
a palm strap coupled to the base plate to secure the base plate to the hand; and
a moveable plate coupled to the base plate through at least a horizontal hinge and a vertical hinge to position the mobile device in a horizontal landscape mode or a vertical portrait mode.

2. The apparatus of claim 1, comprising a tether coupling the base plate to the moveable plate.

3. The apparatus of claim 1, comprising a detachable retainer extending from the moveable plate to at least partially grip a back of the electronic device.

4. The apparatus of claim 3, comprising one or more fixed retainers extending from the moveable plate to at least partially enclose the electronic device.

5. The apparatus of claim 1, wherein the palm strap comprises a palm ventilation hole.

6. The apparatus of claim 1, wherein the palm strap comprises a means for securing the palm strap to the hand

7. The apparatus of claim 1, wherein the base plate comprises a lock tab to secure the moveable plate to the base plate.

8. The apparatus of claim 1, wherein the moveable plate comprises one or more holes, each hole receiving a pin or a screw to secure a mobile device case to the moveable plate.

9. The apparatus of claim 1, comprising one or more slots on the base plate to receive the palm strap.

10. The apparatus of claim 9, wherein the palm strap comprises a brace.

11. The apparatus of claim 1, comprising one or more additional slots to adjust the palm strap to different palm sizes.

12. The apparatus of claim 1, wherein the detachable retainer comprises a snap at one end and wherein the movable plate comprises tracks coupleable to the detachable retainer and locked by the snap at a predetermined length on the tracks.

13. The apparatus of claim 1, comprising a detachable hinge coupled to the base plate and the moveable plate.

14. The apparatus of claim 13, further comprising a pin assembly including a moving pin and a spring inside a chamber.

15. A method for storing and using an electronic device, comprising:
mounting the electronic device on a moveable plate attached to the moveable plate through at least a horizontal hinge and a vertical hinge;
securing the base plate using a palm strap on a hand; and
adjusting the moveable plate through at least a horizontal hinge and a vertical hinge to position the mobile device in a horizontal landscape mode or a vertical portrait mode.

16. The method of claim 15, comprising tethering the base plate to the moveable plate.

17. The method of claim 15, comprising providing a detachable retainer on the moveable plate to at least partially grip a back of the electronic device.

18. The method of claim 15 comprising ventilating the palm strap.

19. The method of claim 15, comprising pushing the moveable plate into a lock tab to secure the moveable plate to the base plate.

20. The method of claim 15, comprising forming one or more holes on the moveable plate, each hole receiving a pin or a screw to secure the mobile device through a device case to the moveable plate.
